(19) United States
(12) Patent Application Publication
(10) Pub. No.: US 2014/0279870 A1
(43) Pub. Date: Sep. 18, 2014

(54) METHOD AND APPARATUS FOR SYNCHRONIZING SHARED DATA IN MOBILE TERMINAL AND SERVER

(71) Applicant: SAMSUNG ELECTRONICS CO. LTD., Suwon-si (KR)

(72) Inventors: Sia Jeffry SAPUTRA, Richardson, TX (US); Xiaogang ZHOU, Allen, TX (US); Sundararajan CHELLAPPAN, Garland, TX (US)

(73) Assignee: SAMSUNG ELECTRONICS CO. LTD., Suwon-si (KR)

(21) Appl. No.: 13/796,220

(22) Filed: Mar. 12, 2013

(51) Int. Cl. G06F 17/30

(52) U.S. Cl. CPC G06F 17/30575
USPC 707/610

(57) ABSTRACT

A method and apparatus for synchronizing shared data in mobile terminal and server. A disclosed method includes, creating a new data entry in a user contact information document of a first user on an address book server and granting a second user access to the data entry, wherein the user contact information document includes an address entry for sharing the data entry with the second user.

### BACKGROUND OF THE INVENTION

1. Field of the Invention

The present invention relates to a converged address book client. More particularly, the present invention relates to a method and apparatus for synchronizing shared data in mobile terminal and server.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

A mobile terminal includes an address book for storing contact information for people that the user desires to contact. Such an address book stores different types of contact sources such as a mobile phone number, a work phone number, a word address, an Instant Messenger (IM) identifier, a social network identifier, and so forth. But because a user of a mobile terminal also uses different electronic devices (e.g., a laptop, a tablet computer, etc.) that have address books, it is difficult to keep the address book of the different devices synchronized.

A Converged Address Book (CAB) has been proposed that stores a user's personal profile and the user's address book in a network that can be accessed from any of the user's devices. Accordingly, the user's address book must be synchronized between the user's client devices and a server that manages the user's client devices. In a CAB system, a first user is able to subscribe to second user's profile as a contact in the first user's address book. The second user's profile is stored in a Personal Contact Card (PCC) document that the second user maintains. If the second user edits any information about that their profile, the CAB system automatically updates the second user's contact information in the first user's address book. Further, in a CAB system, the first user can search for other user's published information.

As proposed, data is transferred in the CAB system in eXtensible Markup Language (XML). Thus, a CAB client includes a User Interface (UI) application that provides a user a graphical interface to use the CAB system. A CAB logic device performs the basic CAB functionality in connection with UI application.

The CAB logic device transmits and receives data from an XML processor to perform general XML processing functions associated with commands from the CAB logic device or data received from the system. The CAB client receives XML Configuration Access Protocol (XCAP) data from an XCAP client for management of XML configuration data. A Session Initiation Protocol (SIP) manager handles document subscriptions and notification services and a database stores the data in for the CAB client. The CAB client also implements a HyperText Transfer Protocol (HTTP) client for the transport of XML data.

When a first user updates their PCC, the address book of users subscribing to the first user's PCC will automatically be updated to reflect the first user's PCC. However, CAB systems do not include other Personal Information Management (PIM) functions such as tasks, calendar functions, note functions, and so forth that can be shared between users. Further, the contact information in the address books are duplicates of a user PCC and the servers maintain the address books based on the subscriptions. Thus, only the user can update their information within the PCC, which is suitable for contact information. However, other functions such as tasks and calendar are different than contact information because these functions may be suitable for collaboration with other users.

Accordingly, there is a need for an apparatus and method for synchronizing shared data in mobile terminal and server.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for synchronizing address book in mobile terminal and server. In accordance with an aspect of the present invention, a method of synchronizing shared data in an address book server is provided. The method includes, creating a new data entry in a user contact information document of a first user on an address book server and granting a second user access to the data entry, wherein the user contact information document includes an address entry for sharing the data entry with the second user.

In accordance with an aspect of the present invention, another method of synchronizing shared data in an address book server is provided. The method includes receiving a shared Personal Information Management (PIM) data entry from a server via a first user, the first user creating the shared PIM data entry on a first terminal associated with the first user, editing the shared PIM data entry via a second terminal; and transmitting the edited PIM data entry to the first terminal associated with the first user, wherein the server determines if the second terminal has edit access to the shared PIM data entry.

In accordance with an aspect of the present invention, an mobile terminal for synchronizing an address book with an address book in a server in provided. The mobile terminal includes a communication unit for sending and receiving data from at least one communication network, a storage unit for storing a Personal Information Management (PIM) application, an input unit for receiving input from a user to control the address book application, and a controller for initiating executing the PIM application in response to input from the user, wherein the PIM application enables sharing of PIM data entries with a plurality of users.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an Converged Address Book (CAB) system according to an exemplary embodiment of the present invention;

FIG. 2 is an illustration of a Personal Contact Card (PCC) schema according to exemplary embodiments of the present invention;

FIGS. 3-5 illustrates signal flow in a CAB system according to exemplary embodiments of the present invention;

FIG. 6 illustrates an example block diagram implementing a CAB client according to exemplary embodiments of the present invention; and

FIG. 7 illustrates a block diagram of a terminal that implements a CAB client according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As a non-exhaustive illustration only, a terminal described herein may refer to mobile devices such as a phone, a cellular phone, a personal digital assistant (PDA), a portable lap-top Personal Computer (PC), a tablet PC, and devices such as a desktop PC, a high definition television (HDTV), like capable of wireless communication or network communication consistent with that disclosed herein.

For purposes of description of exemplary embodiments of the present invention, a terminal will hereinafter be referred to as a terminal.

FIG. 1 illustrates an example Converged Address Book (CAB) system that shares Personal Information Management (PIM) functions according to an exemplary embodiment of the present invention.

To implement such a system, a network 100 (e.g., the Internet, etc.) connects a user domain 105 with a carrier domain 110. The user domain 105 includes an Access Point (AP) 115 that connects devices therein to the network 100. For instance, the AP 115 may be a firewall server associated with an enterprise client or a router associated with a user's home network for connecting to the network 100. The AP 115 communicates with devices in the user domain 105 via wired and/or wireless communication interfaces such as Ethernet, Institute of Electrical and Electronic Engineers (IEEE) 802.11(n), Bluetooth®, and so forth. Generally, the devices within the user domain 105 are based on the user. In the example of FIG. 1, the AP 115 is associated with a home network of a family and includes a computer 120 (e.g., a desktop personal computer, a laptop, a server, etc.), a printer 125, a High Definition TeleVision (HDTV) 130, a set top box 135, a tablet computing device 140, and a femto Base Station (BS) 145. The femto BS 145 is configured to enhance a user's wireless communication of a mobile terminal 150 with a wireless carrier via the AP 115. However, as noted above, the user domain 105 may be an enterprise network associated with a business entity and may comprise different devices (e.g., servers, multi-function printers, etc.).

The computer 120, the tablet 140, and the mobile terminal 150 in the user domain 105 may include an application that includes an Address Book (AB) that is synchronized with an AB stored in the carrier domain 110. For instance, the carrier domain may include a server 155 that implements a CAB function to automatically synchronize the devices in the user domain 105 to have substantially identical ABs. Generally, upon execution of the AB application, the application receives the AB from the server 155. In another example, the AB application receives synchronization information to synchronize the local AB with the AB stored in the server 155.

Further, the AB application may allow a user to update their contact information, such as a Personal Contact Card (PCC) in the server 155, which is a document that contains the user's contact information and may be separate from the AB. The server 155 receives the updated contact information and updates the user's PCC, who can then use another device to view the changes to their PCC. Further, when the server 155 updates the user's PCC, the server 155 also updates the ABs of any other users who have subscribed to the user's PCC, thereby allowing the subscribed individuals to always have the user's most recent contact information in the PCC.

The carrier domain 110 also includes a BS 160 to provide communications services to devices in the user domain 105. For example, when the mobile terminal 150 is moved outside the user domain 105, the mobile terminal 150 may communicate using the telecommunication services provided in the carrier domain 110 via BS 160. In other examples, even while in the user domain 105, the mobile terminal 150 may also communicate using the telecommunication services provided in the carrier domain 110 via BS 160. The carrier domain 110 also includes a Radio Network Controller (not shown) that controls the operations of the BS 160 and communicates with a Core Network (not shown) element that is used to transmit and receive communications with the network 100.

FIG. 2 illustrates an example PCC 200 schema for implementing PIM functions in a CAB system. The PCC 200 includes nodes such as group details 205, a person details 210, and an organization details 215. The group details 205, person details 210, and organization details 215 each include elements therein that are relevant to each node such as names, addresses, and so forth. The PCC 200 includes a new element to maintain a Uniform Resource Locator (URL) that constitutes an address to an item that can be shared with other users. For example, FIG. 2 includes a <ref-url> element with any type of Uniform Resource Indicator (URI) that points to its own element URL via an eXtensible Markup Language (XML) markup such as XML Path Language (XPATH), which is a query language for selecting nodes in an XML document. For example, if a user's PCC URL location is at http://server.com/org.openmobilealliance.cab-pcc/users/sip:userA@server.com/pcc.xml, the <ref-url> will then have value of “http://server.com/org.openmobilealliance.cab-pcc/users/sip:userA@server.com/pcc xml/˜˜/pcc/person-details [@id=“123”]/task-list” which points to the corresponding task list element that is shared in the XPATH expression.

FIG. 3 illustrates a signal flow to share a data entry in a CAB environment between a first and second terminal executing a CAB client.

In the example of FIG. 3, a first user creates a new data entry associated with a PIM function (e.g., a task, a calendar item, a note, etc.) in a CAB client operating on the first terminal. In response, the first terminal transmits a message to the CAB server at step 300. For example, the first terminal transmits a message having an XML Configuration Access Protocol (XCAP) put command, which places the desired content in the first user's PCC. In response, the CAB server creates a new data entry in the first user's PCC corresponding to the data entry at step 302. Table 1 illustrates an example PCC document of the first user in the CAB server.

```
TABLE 1
<pcc>
<person-details id=“123”>
...
<task-list>
    <ref-url>http://server.com/org.openmobilealliance.cab-
        pcc/users/sip:userA@server.com/pcc.xml/~~/pcc/person-
        details[@id=“123”]/task-list</ref-url>
            <task id=“1”>
                <title>buy milk</title>
                <details>chocolate milk for cereal</details>
                <deadline>2012-10-12</deadline>
                <status>needAction</status>
                <ref-url>http://server.com/org.openmobilealliance.cab-
                    pcc/users/sip:userA@server.com/pcc.xml/~~/pcc/
                    person-details[@id=“123”]/task-list/
                    task[@id=“1” ]</ref-url>
            </task>
            <task id=“2”>
                <title>Go to the bank</title>
                <details>get money from bank</details> <deadline>
                2012-10-10</deadline> <status>needAction</status>
                <ref-url>http://server.com/org.openmobilealliance.cab-
                    pcc/users/sip:userA@server.com/pcc.xml/~~/pcc/
                    person-details[@id=“123”]/
                    task-list/task[@id=“2” ]</ref-url>
            </task>
            ...
</task-list>
</person-details>
</pcc>
```

As illustrated in Table 1, the PCC includes elements related to the first user (person) that includes a unique identifier of the user (id). The PCC also includes group such as the task list (task-list) which includes data entries corresponding to the group (task id). The group includes a reference URL (ref-url) that points to the group and each data entry also includes a reference URL (ref-url) that points to each data entry in the group.

After the first user creates the data entry, the first user can use the CAB client on the first terminal to grant a second user of the second terminal access to the data entry, which transmits an update access control document message to the CAB server at step 304. For example, the first terminal need to update an XML Document Management (XDM) access control document (e.g., access control list) associated with the first user's PCC on the CAB server. Accordingly, an XCAP put operation may be implemented at step 304 to update the first user's access control document. After receiving the update access control document message, the CAB server updates the access control document at step 306 as illustrated in the example illustrated in Table 2.

```
TABLE 2
<ap-rules xmlns=“urn:oma:xml:xdm:ap”
  xmlns:cp=“urn:ietf:params:xml:ns:common-policy”
  xmlns:ocp=“urn:oma:xml:xdm:common-policy”
  xmlns:fi=“urn:ietf:params:xml:ns:simple-filter”>
<document-rule path=“pcc”>
<cp:ruleset>
  <cp:rule cp:id=“tasklist”>
    <cp:conditions>
      <cp:identity>
        <cp:one id=“sip:userB@example.com”/>
      </cp:identity>
    </cp:conditions>
    <cp:actions>
      <allow-retrieve/>
      <allow-modify/>
    </cp:actions>
    <cp:transformations>
      <fi:filter-set>
        <fi:ns-bindings>
          <fi:ns-binding prefix=“pcc” urn=“urn:oma:xml:cab:pcc”/>
        </fi:ns-bindings>
        <fi:filter id=“task-list”>
          <fi:what>
            <fi:include type=“xpath”>//pcc:pcc/pcc:person-
            details[@id=“123”]/pcc:task-list</fi:include>
            <fi:include type=“xpath”>//pcc:pcc/pcc:person-
            details[@id=“123”]/pcc:task-list/pcc:task[@id=“1”]
            </fi:include>
            <fi:include type=“xpath”>//pcc:pcc/pcc:person-
            details[@id=“123”]/pcc:task-list/pcc:task[@id=“2”]
            </fi:include>
          </fi:what>
        </fi:filter>
      </fi:filter-set>
    </cp:transformations>
  </cp:rule>
</cp:ruleset>
</document-rule>
</ap-rules>
```

As illustrated in Table 2, the access control document includes elements to identify users who may be granted access to the document. In this example, a Session Initialization Protocol (SIP) address for userB@example.com is granted access to individual data entries (task id) in the group of data entries (task-list). Further, the document includes actions that the second user will be able to take (e.g., retrieve and modify, etc.). In the example of Table 2, the data entries include the XPATH address to the document with the shared data.

After updating the first user's XDM document associated with their PCC, the CAB server updates the second user's AB at step 308. As illustrated in FIG. 3, the second terminal AB may be located on the same CAB server. However, the second terminal AB may be located on a separate server associated with a different wireless carrier, for example. Once the second user's AB is synchronized on the respective CAB server, the CAB server updates the all of the second user's devices that are configured for the CAB service.

Accordingly, at step 310, the CAB server 310 transmits an update AB message to the second terminal of the second user, which updates the AB of the second terminal at step 312. The update AB message includes changes to the second user's AB based on the first user's changes in their PCC. For example, the CAB server may notify the second user using a SIP notification or a push Over The Air (OTA) message that the first user granted access to a PIM function such as a task. In one example, if a SIP notification is used, the message may include a XCAP differential message that includes differential information to update the second user's AB. As described above, the first user added a new task to their PCC and granted the second user permission to retrieve and modify the shared task. Table 3 illustrates an example of the second user's address book after updating the AB to include the shared data entry.

```
TABLE 3
<address-book>
<contact id=“1”>
<person-details id =”123”>
...
<task-list>
    <ref-url>http://server.com/org.openmobilealliance.cab-
      pcc/users/sip:userA@server.com/pcc.xml/~~/pcc/
      persondetails[@id=“123”]/task-list</ref-url>
        <task id=“1”>
            <title>buy milk</title>
            <details>chocolate milk for cereal</details>
            <deadline>2012-10-12</deadline>
            <status>needAction</status>
            <ref-url>http://server.com/org.openmobilealliance.cabpcc/
              users/sip:userA@server.com/pcc.xml/~~/pcc/person-
              details[@id=“123”]/task-list/
              task[@id=“1”]</ref-url>
        </task>
        <task id=“2”>
            <title>Go to the bank</title>
            <details>get cheque from bank</details>
            <deadline>2012-10-10</deadline>
            <status>needAction</status>
            <ref-url>http://server.com/org.openmobilealliance.cabpcc/
              users/sip:userA@server.com/pcc.xml/~~/pcc/person-
              details[@id=“123”]/task-list/task[@id=“2”]</ref-url>
        </task>
...
</task-list>
</person-details>
</contact>
...
</address-book>
```

As illustrated in Table 3, the second user's AB includes elements related to the second user (person-details) including a unique identifier of the second user (id). The AB also includes group such as the task list (task-list) which includes data entries (task id) corresponding to the group. The group includes a reference URL (ref-url) that points to the group and each data entry also includes a reference URL (ref-url) that points to each data entry in the group that the second user may access.

FIG. 4 illustrates a signal flow for a first terminal to update a data entry that is shared by the first terminal with the second terminal in a CAB system.

Initially, the first user of the first terminal updates a data entry that was previously shared with the second user. Accordingly, the first terminal transmits an update data entry message via, for example, an XCAP put operation at step 400. Accordingly, the CAB server will update the first user's PCC document to reflect the updates to the first user's PCC at step 402. At step 404, the CAB server determines if other terminal ABs (e.g., the second terminal's AB) need to be updated based on the update to the first user's PCC. For instance, the CAB server determines if the second user is subscribed to the first user's PCC and then determines if the first user has granted shared the data entry with the second user. Accordingly, the CAB server updates the second terminal AB stored on the CAB server at step 408.

After updating the second terminal AB stored on the CAB server, the CAB server synchronizes all devices of the second user (e.g., the second terminal) receiving the CAB service. Accordingly, the CAB server transmits an update AB message to the second terminal at step 410, which updates the AB on the second terminal at step 412. For example, the CAB server may notify the second user using a SIP notification, a Push Client Application Interface (Push CAI), or a push Over The Air (OTA) message. In one example, if a SIP notification is used, the message may include a XCAP differential message that includes differential information to update the second user's AB. After step 412, the second terminal has been updated to reflect the changes that the first user made. Further, the second terminal may display a message for the second user indicating the change made to the AB.

FIG. 5 illustrates a signal flow for the second terminal to update a data entry that is shared by the first terminal in a CAB environment.

Initially, the second user of the second terminal updates a data entry that was previously shared by the first user. Specifically, in the event the second user wants to collaborate using the shared data entry, the second user will use the address in the shared task element (e.g., ref-url). Accordingly, the second terminal transmits an update data entry message via, for example, an XCAP put operation at step 500. In response to receiving the update data entry message, the CAB server determines if the second terminal has edit access to update the data entry in the first user's PCC at step 502. For example, the CAB server may review the first user's access control document as described above to determine if the second user can modify a particular data entry of the first user's PCC. If the second user has edit access, the CAB server updates the first user's PCC on the CAB server at step 504. At step 506, the CAB server may transmit an acknowledgement message to the second terminal to indicate successful update to the first user's PCC.

After updating the first user's PCC on the CAB server, the CAB server synchronizes all devices of the first user (e.g., the second terminal) receiving the CAB service. Accordingly, the CAB server transmits an update AB message to the second terminal at step 508, which updates the first user's PCC on the first terminal at step 510. For example, the CAB server may notify the first user using a SIP notification or a push OTA message. In one example, if a SIP notification is used, the message may include a XCAP differential message that includes differential information to update the second user's AB. After step 510, the first terminal has been updated to reflect the changes that the second user made.

After updating the first user's PCC, the first terminal may provide a message to indicate that a change to the PCC has been made. Further, the first user will be able to determine any changes in their PCC document via a PCC history document. Further, the second user's AB will be updated based any further changes to the first user's PCC. In another example, the first user may also require the PCC to be changed on a second approval by the first user, thereby allowing more granular control to the PIM functions.

FIG. 6 illustrates a block diagram of an example CAB client 600 that is executed on a terminal in conjunction with a CAB service.

The CAB client 600 sends and data via an HTTP client 605 using any suitable communication function of the mobile terminal (e.g., IEEE 802.11(n), Bluetooth®, 6rd Generation Partnership Program (3GPP), etc.). The received data is passed to a CAB logic device 610, which communicates with an XML processor 615 for data processing. The CAB logic device 610 send and receives XCAP data from an XCAP client 618 for management of XML configuration data. A SIP processor 620 handles document subscriptions and notification services for the CAB client 600. The CAB client 600 receives input from a UI Interface 625 and the CAB logic device 610 outputs AB information in response to the input via the UI interface 625. The CAB logic device 610 stores and retrieves data from a database 630 or other suitable storage device (e.g., a cache, a non-volatile storage memory, etc.).

FIG. 7 is block diagram schematically illustrating a configuration of a mobile terminal according to an exemplary embodiment of the present invention.

Referring to FIG. 7, a terminal 700 according to an exemplary embodiment of the present invention includes at least one controller 710, a storage unit 720, a display unit 730, an input unit 740, an audio-processing unit 750, and a communication unit 760. As an example, the terminal 700 having such a configuration may store at least one AB application for displaying and editing an AB in connection with a CAB service.

According to exemplary embodiments of the present invention, the terminal 700 may further include various sensors for determining the environment. For example, the mobile terminal may include a Global Positioning System (GPS) sensor for determining the location of the mobile terminal. The mobile terminal may also include a date and time sensor.

Hereinafter, each component of the terminal 700 will be explained in detail.

The communication unit 760 is configured to send and receive communication with various devices using various communications techniques. For example, the communication unit includes a Bluetooth® function, an IEEE 802.11(n) function, an Ethernet function, and a 3GPP communication function to communicate with different devices. According to exemplary embodiments of the present invention, the communication unit 760 sends and receives data to synchronize a PCC of the terminal 700 with a PCC on a server. Further, the communication unit 760 sends and receives data to synchronize an AB of the terminal 700 with an AB on a server.

The audio processing unit 750 may be formed as an acoustic component. The audio processing unit 750 transmits and receives audio signals, and encodes and decodes the audio signals. For example, the audio processing unit 750 may include a coder-decoder (codec) and an audio amplifier. The audio processing unit 750 is connected to a Microphone (MIC) and a Speaker (SPK). The audio processing unit 750 converts analog voice signals inputted from the Microphone (MIC) into digital voice signals, generates corresponding data for the digital voice signals, and transmits the data to the controller 710. Further, the audio processing unit 750 converts digital voice signals inputted from the controller 710 into analog voice signals, and outputs the analog voice signals through the Speaker (SPK). Further, the audio processing unit 750 may output various audio signals generated in the mobile terminal 700 through the Speaker (SPK). For example, the audio processing unit 750 can output audio signals according to an audio file (e.g. MP3 file) replay, a moving picture file replay, and the like through the speaker.

The input unit 740 may include input keys and function keys for receiving user input. For example, the input unit 740 may include input keys and function keys for receiving an input of numbers or various sets of letter information, setting various functions, and controlling functions of the mobile terminal 700. For example, the input unit 740 may include a calling key for requesting a voice call, a video call request key for requesting a video call, a termination key for requesting termination of a voice call or a video call, a volume key for adjusting output volume of an audio signal, a direction key, and the like. In particular, the input unit 740 according to exemplary embodiments of the present invention may transmit to the controller 710 signals related to an input for viewing an AB, editing contact information of the user, editing shared or PIM function data, or initiating contact with a person listed in the AB. Further, according to exemplary embodiments of the present invention, the input unit 740 may transmit to the controller 710 signals relating to selection of an AB entry to display more information of the AB entry, edit the AB entry, delete the AB entry, or request a new AB entry, for example. As another example, the user may use the input unit 740 to add and edit data into the AB such as a task entry or a calendar entry. Such an input unit 740 may be formed by one or a combination of input means such as a touch pad, a touchscreen, a button-type key pad, a joystick, a wheel key, and the like.

The display unit 730 displays information inputted by user or information to be provided to user as well as various menus of the mobile terminal 700. For example, the display unit 730 may provide various screens according to a user of the mobile terminal 700, such as an idle screen, a message writing screen, a calling screen, and the like. In particular, the display unit 730 according to exemplary embodiments of the present invention can display an AB application for displaying of an AB on the mobile terminal 700. As an example, the display unit 730 can output an interface with which a user may view the AB and the entries in the AB. The AB may also include additional PIM functions such as a calendar function, a task function, or a notes function. For example, the display unit 730 may display an interface which the user may manipulate or otherwise enter inputs via a touch screen to enter inputs for selecting and viewing function of the AB on the mobile terminal 700. The display unit 730 can be formed as a Liquid Crystal Display (LCD), an Organic Light Emitting Diode (OLED), an Active Matrix Organic Light Emitting Diode (AMOLED), and the like. However, exemplary embodiments of the present invention are not limited to these examples. Further, the display unit 730 can perform the function of the input unit 740 if the display unit 730 is formed as a touch screen.

The storage unit 720 can store user data, and the like, as well a program which performs operating functions according to an exemplary embodiment of the present invention. For example, the storage unit 720 may store a program for controlling general operation of a mobile terminal 700, an Operating System (OS) which boots the mobile terminal 700, and application program for performing other optional functions such as an AB function, a camera function, a sound replay function, an image or video replay function, a Near Field Communication (NFC) function, and the like. Further, the storage unit 720 may store user data generated according to a user of the mobile terminal, such as, for example, a text message, a game file, a music file, a movie file, and the like. In particular, the storage unit 720 according to exemplary embodiments of the present invention may store an AB that includes function that a second user may view and edit using a different terminal.

According to exemplary embodiments of the present invention, the terminal 700 comprises at least one controller 710. The at least one controller 710 may control general operation of the mobile terminal 700. For example, the controller 710 may control operation of the various components or units included in the mobile terminal 700. The controller 710 may transmit a signal to the various components included in the mobile terminal 700 and control a signal flow between internal blocks of the mobile terminal 700. In particular, the controller 710 according to exemplary embodiments of the present invention can include of an AB having PIM function. To this end, the controller 710 may transmit data to a server to store PIM functions such as a calendar function or a task list function. The user of the terminal may allow another user to edit and modify PIM functions from a different terminal.

Although the above examples describe sharing a task, other PIM functions may be implemented such as calendar functions, note functions, and so forth to allow sharing of data in a CAB system. Other examples may include forwarding, importing, and exporting additional functions that may or may not be shared in the CAB system. For instance, the examples described may be used to share data and/or information via a third party such as a cloud computing service.

A CAB client according to exemplary embodiments of the present invention may be implemented in an executable program command form by various computer means and be recorded in a non-transitory computer readable recording medium. The computer readable recording medium may include a program command, a data file, and a data structure individually or a combination thereof. The program command recorded in a recording medium may be specially designed or configured for exemplary embodiments of the present invention, or may be known to a person having ordinary skill in the art.

The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, a hardware device such as ROM, RAM, flash memory storing and executing program commands, and the like. Further, the program command includes a machine language code created by a compiler and a high-level language code executable by a computer using an interpreter. The foregoing hardware device may be configured to be operated as at least one software module to perform an operation of exemplary embodiments of the present invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

Although certain methods, systems, and articles of manufacture have been described herein, the scope of coverage of this patent is not limited thereto. To the contrary, this patent covers all methods, systems, and articles of manufacture fairly falling within the scope of the appended claims either literally or under the doctrine of equivalents.

What is claimed is:

1. A method of synchronizing shared data in an address book server, the method comprising:
creating a new data entry in a user contact information document of a first user on an address book server; and
granting a second user access to the data entry,
wherein the user contact information document includes an address entry for sharing the data entry with the second user.

2. The method of claim 1, wherein the data entry comprises at least one Personal Information Management (PIM) entry.

3. The method of claim 1, wherein the address book server comprises a Converged Address Book (CAB) server.

4. The method of claim 3, wherein the CAB server is operated by a wireless carrier.

5. The method of claim 1, further comprising:
in response to the granting of the access, updating an address book of the second user based on the data entry; and
transmitting a notification message to the second user indicating access to the data entry.

6. The method of claim 1, further comprising:
receiving a request from the second user to update the data entry;
determining the second user's access level with respect to the data entry;
if the access level allows the second user to update the data entry, updating the data entry in the address book server.

7. The method of claim 6, further comprising:
transmitting a data entry update message to a terminal of the first user to notify the first user the data entry has been updated and to update the first user's contact information document on the terminal.

8. The method of claim 1, further comprising:
receiving a request from the first user to update the data entry;
in response to the request, determining if the second user address book should be updated;
if the second user address book should be updated, updating the second user address book; and
transmitting an address book update message to the second user.

9. A mobile terminal for synchronizing an address book with an address book in a server, the apparatus comprising:
a communication unit for sending and receiving data from at least one communication network;
a storage unit for storing a Personal Information Management (PIM) application;
an input unit for receiving input from a user to control the address book application; and
a controller for initiating executing the PIM application in response to input from the user,
wherein the PIM application enables sharing of PIM data entries with a plurality of users.

10. The mobile terminal of claim 9, wherein the PIM application transmits and receives synchronization information from a Converged Address Book (CAB) server.

11. The mobile terminal of claim 10, wherein the PIM application includes a control creating a new data entry in a user contact information document of a first user on an address book server.

12. The mobile terminal of claim 11, wherein the PIM application includes a control for sharing the data entry of the first user with a second user.

13. The mobile terminal of claim 12, wherein the control for sharing the data entry causes a message to be transmitted to a mobile terminal associated with the second user, wherein the message updates a PIM application of the mobile terminal associated with the second user.

14. The mobile terminal of claim 12, wherein the PIM application includes controls for synchronizing the data entry of the first user based on edits from the second user.

15. The mobile terminal of claim 14, wherein the controls for synchronizing the data entry synchronizes the data entry of the first user based on edits provided by the second user.

16. The mobile terminal of claim 12, wherein the CAB server determines if the second user determines if the first user can edit the data entry of the first user.

17. The mobile terminal of claim 12, wherein the PIM application receives a shared data entry from a second user, wherein the shared data entry originates from a second mobile terminal associated with the second user.

18. The mobile terminal of claim 12, wherein the data entry comprises at least one PIM entry.

19. The mobile terminal of claim 17, wherein the shared data entry comprises at least one PIM entry.

20. A method of synchronizing shared data in an address book server, the method comprising:
receiving a shared Personal Information Management (PIM) data entry from a server via a first user, the first user creating the shared PIM data entry on a first terminal associated with the first user;
editing the shared PIM data entry via a second terminal; and
transmitting the edited PIM data entry to the first terminal associated with the first user,
wherein the server determines if the second terminal has edit access to the shared PIM data entry.
